(19) United States
(12) Patent Application Publication
(10) Pub. No.: US 2006/0187603 A1
(43) Pub. Date: Aug. 24, 2006

(54) Function selection system

(75) Inventor: Shih-Jen Chuang, Hsin Chu (TW)

Correspondence Address: EDWARDS & ANGELL, LLP, P.O. BOX 55874, BOSTON, MA, 02205, US

(73) Assignee: RDC Semiconductor Co., Ltd., Taiwan (TW)

(21) Appl. No.: 11/157,385

(22) Filed: Jun. 20, 2005

(30) Foreign Application Priority Data
Feb. 23, 2005 (TW) 094105350

(51) Int. Cl. H02H 3/08

(52) U.S. Cl. 361/93.1

(57) ABSTRACT

A function selection system is applicable in an integrated circuit having at least one functional signal line for controlling potential of the functional signal line to select a functionality provided by the integrated circuit. The function selection system at least has a power supply module, a switching module, and a connection module. The power supply module is used to provide power required for operation of the system. The switching module is electrically connected to the power supply module and the functional signal line of the integrated circuit for controlling the magnitude of the current provided by the power supply module flowing through the switching module to be outputted. The connection module is electrically connected to the switching module, the functional signal line of the integrated circuit and a ground terminal, and is used to determine a connection relationship with the ground terminal according to the outputted current magnitude from the switching module. The connection module also controls the output potential of the functional signal line of the integrated circuit through different connection relationships, such that the required functionality can be determined based on the potential of the functional signal line, thereby improving the applicability of the integrated circuit.

### FIELD OF THE INVENTION

The present invention relates to a function selection system, and more particularly, to a function selection system applicable in an integrated circuit for controlling the output potential of a functional signal line of the integrated circuit to select functionalities provided by the integrated circuit.

### DESCRIPTION OF THE PRIOR ART

The development of transistors in 1947 created a revolutionary change in the semiconductor industry, which replaced the vacuum tubes in traditional electronic products, largely reducing the product size. Comparing to the enormous size of the vacuum tubes, the micron-sized transistors have become the main elements in the microelectronics.

In order to produce high-performance products, the integrated circuit (IC) technology was developed in 1960, capable of integrating hundreds of transistors into one single chip. Such integrated circuits that based on the microelectronic elements have become the foundation of all modernized electronic products. The result of continuous reduction in the size of the transistors allows the technologies of small scale integrated circuit (SSI), medium scale integrated circuit (MSI), and large scale integrated circuit (LSI) to be further developed. Very large scale integrated circuit (VLSI) and ultra large scale integrated circuit (ULSI) have now been commonly applied in the field.

At present, many integrated circuit designers and manufacturers often design integrated circuits according to the clients' requests. Due to different clients have different demands on the functions of the integrated circuits, the manufacturers must design customized integrated circuit to tailor the requirements of functionalities of the ICs made by different clients. As a result, this has brought the integrated circuit designers an enormous predicament.

Firstly, the integrated circuit layout designers must repeatedly perform integrated circuit layout designing process for the ICs to provide designated functions. Each design only satisfies one demand, and this affects the integrated circuit designers' work efficiency. At the same time, from the integrated circuit manufacturer's perspective, ICs with different functions cause huge inconvenience in a series of operations such as batch production, management, shipment, inventory, transportation and so on.

Therefore, following the continuous development in automation technology for the semiconductor and electronic design, the technology of integrating multiple functions into one single integrated circuit has become the developing trend in the field. The integrated circuit designer offers ICs with multiple functionalities, where functionalities required by the client can be selected while other unwanted functionalities can be masked, thus batch production is possible, and the multi-function ICs can be applied to specific system. Accordingly, it prevents the integrated circuit designer from repetition of work and allows the integrated circuit manufacturers to manage with enhanced convenience.

However, application of multi-function ICs must involve the selection of required functions. Therefore, there is a need for providing a simple, inexpensive technique for selecting functionalities of an integrated circuit.

### SUMMARY OF THE INVENTION

In order to improve from the above shortcomings, an objective of the present invention is to provide a function selection system applied in an integrated circuit to provide the designated functions on the integrated circuit according to the clients' requested selection.

Another objective of the present invention is to provide a function selection system, which allows the integrated circuit manufacturers to lower down their design costs, and brings conveniences to production and inventory management.

In order to achieve the above objectives, the present invention provides a function selection system that can be applied in an integrated circuit having at least one functional signal line for controlling potential of the functional signal line to select a functionality provided by the integrated circuit. The function selection system at least has a power supply module, a switching module, and a connection module. The power supply module is used to provide power required for operation of the system. The switching module is electrically connected to the power supply module and the functional signal line of the integrated circuit for controlling the magnitude of the current provided by the power supply module flowing through the switching module to be outputted. The connection module is electrically connected to the switching module, the functional signal line of the integrated circuit and a ground terminal, and is used to determine a connection relationship with the ground terminal according to the outputted current magnitude from the switching module. The connection module also controls the output potential of the functional signal line of the integrated circuit through different connection relationships, such that the required functionality can be determined based on the potential of the functional signal line.

The switching module comprises a switch unit and a current-limiting unit. The switch unit selectively acts as a current flowing path for the current outputted by the power supply module based on its switching actions. The current-limiting unit is used to control current magnitude provided by the power supply module and flowing through the switching module to be outputted when the switch unit is turned “off”.

In comparison with the prior art, the present invention controls the switching actions of the switch unit through programming. It further changes the connection relationship between the connection module and the ground terminal, so as to selectively output a logical high potential for setting a first function for the integrated circuit, or output a logical low potential for setting a second function, thereby meeting the demands of clients by providing the required functionality on the integrated circuit.

Moreover, the switch unit of the present invention can be either a metal-oxide-semiconductor field effect transistor (MOSFET) or a junction field effect transistor (JFET). The current-limiting unit is a resistor. The connection module is metal conductor that has fusible current threshold value. Also, the required quantity of the function selection system of the present invention is dependent on the actual numbers of functions requested to be provided by the integrated circuit.

Therefore, as for integrating multi-functions in a single integrated circuit, the function selection system of the present invention allows the user to select the required functions in a simple and fast way, also enhances the compatibility of the ICs and be advantageous for the production and inventory management of the ICs.

### BRIED DESCRIPTION OF THE DRAWINGS

A better understanding of the present invention can be obtained when the forgoing detailed description is considered in conjunction with the following drawings, in which:

FIG. 1 is a block diagram showing a fundamental structure of the function selection system of the present invention;

FIG. 2 is a diagram of a preferred embodiment of the function selection system of the present invention; and

FIG. 3 is a block diagram of a fundamental structure of the function selection system of the present invention applied in an integrated circuit with at least four functions.

### DETAILED DESCRIPTION OF THE PREFFERED EMBODIMENT

The descriptions below of specific embodiments are to illustrate the present invention. Others skilled in the art can easily understand other advantages and features of the present invention from contents disclosed in this specification. The present invention can be carried out or applied through different embodiments. Every details of this specification can be modified based on different viewpoints and applications yet still within the scope of the present invention.

The embodiments below are only to illustrate aspects of the present invention; it should not be construed as to limit the scope of the present invention in any way.

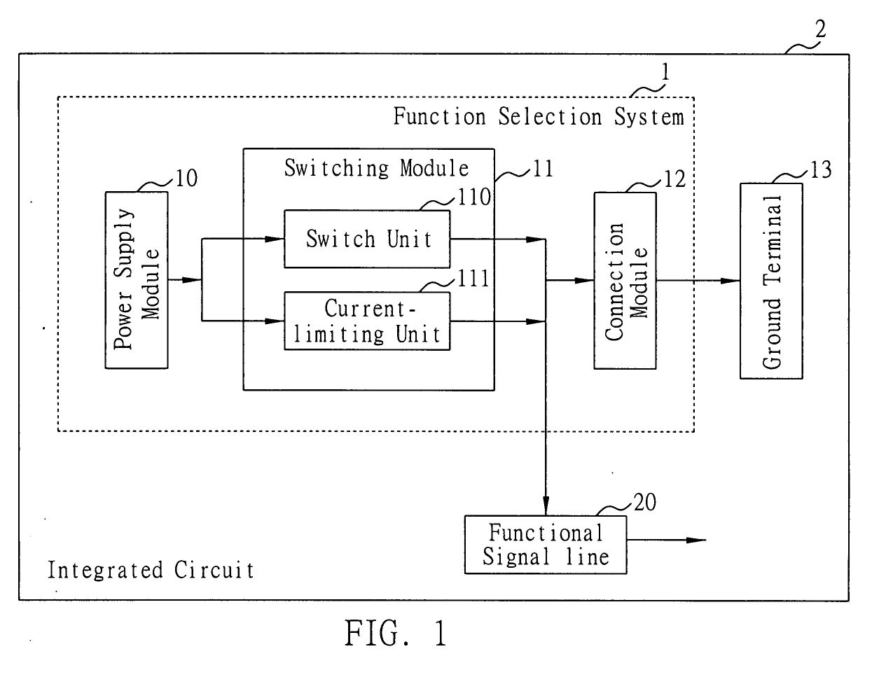

FIG. 1 shows a block diagram of the fundamental structure of a function selection system according to the present invention. The function selection system 1 of present invention is applicable in an integrated circuit 2. The integrated circuit 2 at least provides a first function and a second function. For example, in this detailed description of the embodiment, the first function is amplifying power by ten times, and the second function is amplifying the power by a hundred times. One may employ the function selection system 1 of the present invention to perform the selection of power amplification factor to accommodate requirements of different systems.

Specifically, when a functional signal line 20 of the integrated circuit 2 is at a logic high potential, the integrated circuit 2 will apply the first function to amplify the power by ten times. When the functional signal line 20 of the integrated circuit 2 is at a logic low potential, then the integrated circuit 2 will apply the second function to amplify the power by 100 times. As shown in the diagram, the function selection system 1 comprises a power supply module 10, a switching module 11, and a connection module 12, where the switching module 11 comprises a switch unit 110, and a current-limiting unit 111.

The power supply module 10 is used to provide power required for operation of the system.

The switching module 11 is electrically connected to the power supply module 10, and is used to control current magnitude provided by the power supply module 10. The switching module 11 turns on or off the current flow via the switching action of the switch unit 110. The current-limiting unit 111 is used to limit the magnitude of current flowing through the switching module when the switch unit 110 is not set to be the current flowing path.

The switch unit 110 is, for example, a metal oxide semiconductor field effect transistor (MOSFET) or a junction field effect transistor (JFET). Control of the switching actions of the switch unit 110 can be programmed. The current-limiting unit is for example a resistor.

The connection module 12 is electrically connected to the switching module 11 and the ground terminal 13, and is used to determine a connection relationship with the ground terminal 13 according to the outputted current magnitude from the switching module 11. The connection module 12 can be a metal conductor having fusible current threshold value.

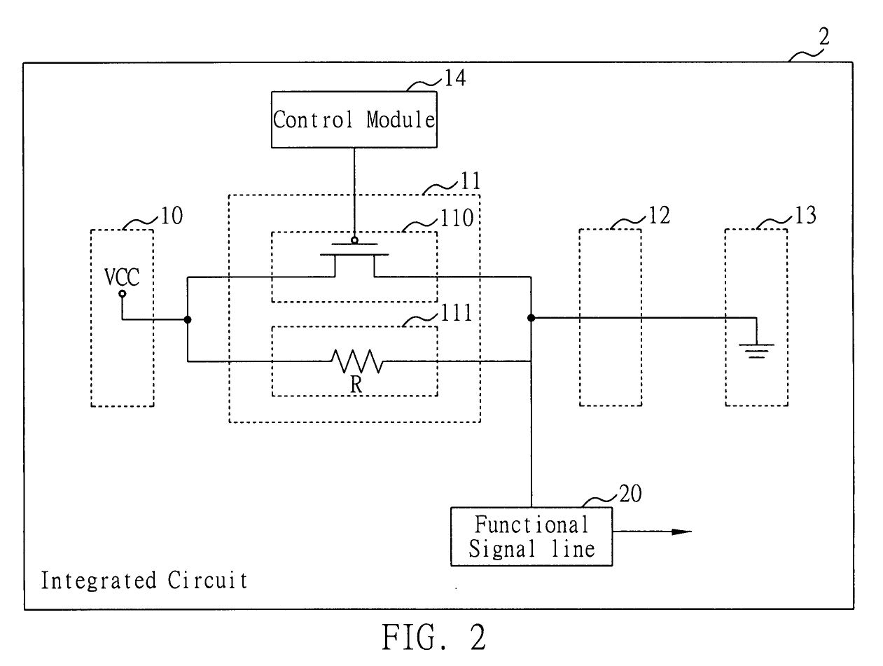

FIG. 2 is a circuit diagram of a preferred embodiment of the function selection system 1 according to the present invention. In this embodiment, the switch unit 110 is a PMOS transistor. The source of the PMOS transistor is electrically connected to the power supply module 10; the drain thereof is electrically connected to the connection module 12; the gate thereof is connected to a control module 14. The control module 14 can be a mass production program used by the manufacturer to perform mass production of the integrated circuit or an application program used by the client to perform function configurations of the integrated circuit.

The potential of the gate is programmable. When the potential of the gate is programmed to be high, the switch unit 110 is turned off, that is, the PMOS transistor is off. At the same time, the current in the system flows from the power supply module 10 (i.e. Vcc) via the current-limiting unit 111 and the connection module 12 into the ground terminal 13.

As shown in the diagram, the current-limiting unit 111 is a resistor with resistance value R, and the connection module 12 is a metal conductor that has a characteristic of fusible current threshold value. Therefore it is necessary to choose a large resistance value R for the current-limiting unit 111 to ensure that when the switch unit 110 is off (i.e. when the PMOS transistor is cut off), the magnitude of the current limited by the current-limiting unit 111 (i.e. the resistance value R of the resistor) is smaller than the fusible current threshold value of the metal conductor, so that the metal conductor is equivalent to a short circuit under the condition that the metal conductor is not fused. Correspondingly, the potential of the functional signal line 20 of the integrated circuit 2 is at the same potential of the ground terminal 13, i.e. at logic low, so that the integrated circuit 2 will then apply the second function by amplifying the power by 100 times.

Similarly, the potential of the gate is programmed to be at logic low, the switch unit 110 is switched on, that is the PMOS transistor is on. At the same time, the current in the system flows from the power supply module 10, Vcc, via the switch unit 110, (i.e. the turned-on PMOS transistor) and the connection module 12 into the ground terminal 13.

As indicated in the diagram, the switch unit 110 is a PMOS transistor, and when it is in the on-status, the resistance value is at the minimum. However, the connection module 12 is a metal conductor that has a characteristic of fusible current threshold value. Thus, as the switch unit 110 is switched on, and the magnitude of system current is greater than the fusible current threshold value of the metal conductor, the metal conductor is equivalent to an open circuit. Correspondingly, the potential of the functional signal line 20 of the integrated circuit 2 is at the same potential of the power supply module 10, that is, at the logic high, and the integrated circuit 2 will then apply the first function by amplifying the power by 10 times.

As been described above, the control module 14 performs controls on the switch unit 110 according to different demands. The control module 14 can be a control program used by the integrated circuit manufacturers to perform specific steps subsequent to the mass production programming of integrated circuits 2. Namely when the client requests the first function or the second function of the multi-functional integrated circuit 2, corresponding operations are performed based on the client's demand. Furthermore, this control program can also be integrated into the multi-functional integrated circuit 2.

The required quantity of the function selection system of the present invention depends on the actual number of functions provided by the integrated circuit, that is, the quantity of the switching module 11 and the connection module 12 are dependent on the number of the functional signal lines of the integrated circuit.

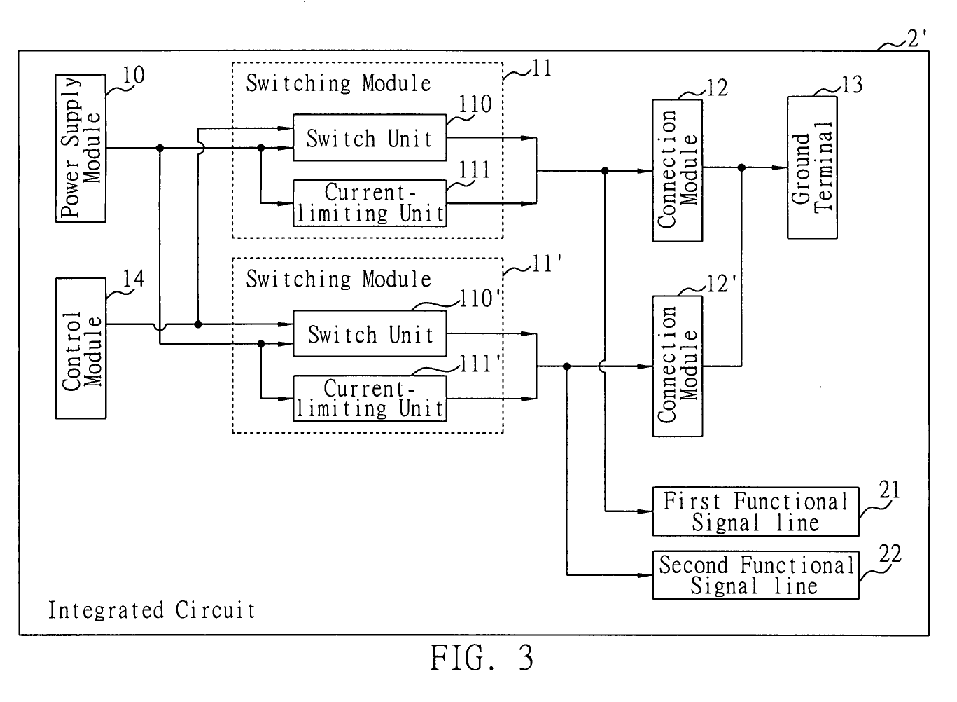

FIG. 3 is a block diagram showing a fundamental structure of the function selection system 1 of the present invention applying in an integrated circuit 2 that consists of three or four functions. As shown in the diagram, when the integrated circuit 2 provides four functions, it is needed to have to two sets of the function selection system 1 to obtain the potential statuses (22 different functions) of the functional signal lines corresponding to four different functions. Similarly, when the integrated circuit 2 provides five to eight functions, three sets of function selection system 1 are needed to obtain eight different statuses of the functional signal lines (2³ different functions).

In comparison with the prior art, the function selection system 1 of the present invention is mainly based on the programmed switch unit 110 to execute the switching action, which in turns changes the connection relationship between the connection module 12 and the ground terminal 13 to selectively output a logic high potential to select the first function of the integrated circuit or a logic low potential to select the second function of the integrated circuit. This will achieve the purpose of selecting the corresponding functions of the integrated circuits according to the client's request.

Besides, the switch unit 110 of the function selection system 1 of the present invention can be either a metal-oxide-semiconductor field effect transistor (MOSFET) or a junction field effect transistor (JFET). The current-limiting unit can be a resistor. The connection module can be a metal conductor that has fusible current threshold value. Also, the required quantity of the function selection system of the present invention depends on the actual number of functions requested to be provided by the integrated circuit.

Therefore, through the function selection system 1 of the present invention, the users are allowed to select the desired functions using a simple and fast way, enhancing the practicability of integrating multiple functions in a single integrated circuit, and also providing an easier management for the integrated circuits production and inventory.

While the invention has been described in detail with reference to specific embodiments thereof, it will be apparent in the art that various changes and modifications can be made, and equivalents employed, without departing from the scope of the claims. An example would be the PMOS transistor, the resistor and the metal conductor as indicated in FIG. 2, these can also be replaced by other electrical functional components or electric circuits of the similar functions, the components are not restricted to only that have been shown in the diagram.

What is claimed is:

1. A function selection system applicable in an integrated circuit having at least one functional signal line for controlling potential of the function signal line to select a functionality to be provided by the integrated circuit, the system comprising:
a power supply module for providing power required for operation of the system;
at least one switching module electrically connected to the power supply module and the functional signal line of the integrated circuit for controlling the magnitude of a current provided by the power supply module and outputted by the switching module; and
at least one connection module electrically connected to the switching module, the functional signal line of the integrated circuit and a ground terminal for determining a connection relationship with the ground terminal according to the magnitude of the current outputted from the switching module.

2. The system as claimed in claim 1, wherein the switching module comprises:
a switch unit electrically connected to the power supply module at one end thereof, and to the connection module and the functional signal line of the integrated circuit at the other end thereof, the switch unit selectively acting as a current flowing path for the current outputted by the power supply module based on its switching actions; and
a current-limiting unit in parallel with the switch unit for providing a current flowing path for the current outputted by the power supply module and limiting the magnitude of the current when the switch unit is turned off.

3. The system as claimed in claim 2, wherein control for the switching actions of the switch unit is programmed.

4. The system as claimed in claim 2, wherein the switch unit is one of a metal-oxide-semiconductor field effect transistor (MOSFET) and a junction field effect transistor (JFET).

5. The system as claimed in claim 2, wherein the current-limiting unit is a resistor.

6. The system as claimed in claim 2, wherein the connection module is a metal conductor that has a fusible current threshold value, when the switch unit is turned on, the power supply module is allowed to output current via the switch unit to the metal conductor, when the outputted current magnitude is greater than the fusible current threshold value, the metal conductor is fused, and so the current is outputted to the functional signal line of the integrated circuit electrically connected to the switch unit, such that the functional signal line outputs a logic high potential and sets the functionality of the integrated circuit to a first function, when the switch unit is turned off, the outputted current provided by the power supply module flows through the current-limiting unit, and so the magnitude of the outputted current is limited, such that the limited current is less than the fusible current threshold value and when the limited current flows through the metal conductor, the functional signal line of the integrated circuit outputs a logic low potential, and sets the functionality of the integrated circuit to a second function.

7. The system as claimed in claim 1, wherein the connection module is a metal conductor that has a fusible current threshold value.

8. The system as claimed in claim 1, wherein quantities of the switch modules and connection modules are determined by the number of the functional signal lines of the integrated circuit.
